(19) United States
(12) Patent Application Publication
(10) Pub. No.: US 2009/0007167 A1
(43) Pub. Date: Jan. 1, 2009

(54) Video-Based Networking System with Reviewer Ranking and Publisher Ranking

(75) Inventor: Arturo Artom, Torino (IT)

Correspondence Address: FLIESLER MEYER LLP, 650 CALIFORNIA STREET, 14TH FLOOR, SAN FRANCISCO, CA, 94108, US

(73) Assignee: YOUR TRUMAN SHOW, INC., San Francisco, CA (US)

(21) Appl. No.: 12/138,329

(22) Filed: Jun. 12, 2008

Related U.S. Application Data
(60) Provisional application No. 60/934,355, filed on Jun. 12, 2007.
(60) Provisional application No. 60/934,343, filed on Jun. 12, 2007.

(51) Int. Cl. H04H 60/33; G06F 3/048; G06F 17/30

(52) U.S. Cl. 725/9; 715/751; 707/10; 707/E17.044

(57) ABSTRACT

A video-based networking system is described, having a ranking system for publishers of videos and for reviewers of videos. The members of the network can publish their videos, view videos posted by others, and provide a review of videos posted by others. The videos may be rated and reviewed. The members also may be ranked as a publisher and as a reviewer by other members of the network. The ranking of publishers and reviewers can be based on the average value of ratings and the number of views of a video or a review. The ranking algorithm can be a moving-average mathematical function. In some embodiments the video based networking system comprises a video based social networking system.

### CLAIM OF PRIORITY

The present application claims the benefit of U.S. Provisional Patent Application No. 60/934,355, entitled VIDEO-BASED NETWORKING SYSTEM WITH PUBLISHER RANKING, by Arturo Artom, filed on Jun. 12, 2007 (Attorney Docket No. YSTC-01002US0); and U.S. Provisional Patent Application 60/934,343 entitled VIDEO-BASED NETWORKING SYSTEM WITH REVIEWER RANKING, by Arturo Artom, filed on Jun. 12, 2007 Attorney Docket No. YTSC-01001US0), both of which are incorporated herein by reference in their entireties.

### CROSS REFERENCE TO RELATED APPLICATION

The following commonly owned, co-pending United States Patent Application is related to this application and is incorporated by reference herein in its entirety:

U.S. patent application Ser. No. ______ , entitled VIDEO-BASED NETWORKING SYSTEM WITH A VIDEO-LINK NAVIGATOR, by Arturo Artom, filed on Jun. 12, 2008 (Attorney Docket No. YTSC-1000US1).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to electronic videos and more particularly to providing rankings for publishers and reviewers of videos in a video-based social networking system.

### BACKGROUND OF THE INVENTION

Video and other auditory and visual technology has become increasingly popular over the recent years due to its availability on the Internet. Various websites, such as Youtube® have surfaced, which allow video sharing and viewing by way of almost any computing device connected to the Internet. In general, these sites allow a user to upload a video, which can then be viewed and commented on by other users. Once a video is uploaded to the system, users are typically allowed to rate it based on their personal taste and preferences.

In many instances, it would be desirable to encourage users to rate, rank, and comment on videos and otherwise participate in various social networking activities. There is a shortage of features which allow the service provider to encourage these types of activities in a user-friendly and rewarding fashion. For example, while some video websites provide an ability for the user to rate a video, most such sites fail to provide incentives for the user to perform such tasks. Furthermore, it may be desirable to use the information collected regarding the social networking activities in a meaningful manner.

### BRIEF SUMMARY

Embodiments of the present invention provide a video-based networking system. In exemplary embodiments, members of a network can publish their videos, view videos posted by others, and provide a review of videos posted by others. The videos may be ranked based on the reviews. The members also may be ranked as a publisher and as a reviewer by other members of the network. In some embodiments the video based networking system comprises a video based social networking system.

### BRIEF DESCRIPTION OF THE DRAWINGS

FIG. 1 is an illustration of an exemplary screenshot of a webpage on the video networking system, in accordance with various embodiments.

FIG. 2 is an illustration of an exemplary screenshot of a webpage on the video networking system having a video rating system, in accordance with various embodiments.

FIG. 3 is an illustration of an exemplary screenshot of a webpage on the video networking system having review rating system, in accordance with various embodiments.

FIG. 4 is an illustration of an exemplary screenshot of a webpage on the video networking system having a listing of reviews, in accordance with various embodiments.

FIG. 5 is an illustration of an exemplary screenshot of a webpage on the video networking system having a reviewer ranking display and a publisher ranking display, in accordance with various embodiments.

### DETAILED DESCRIPTION

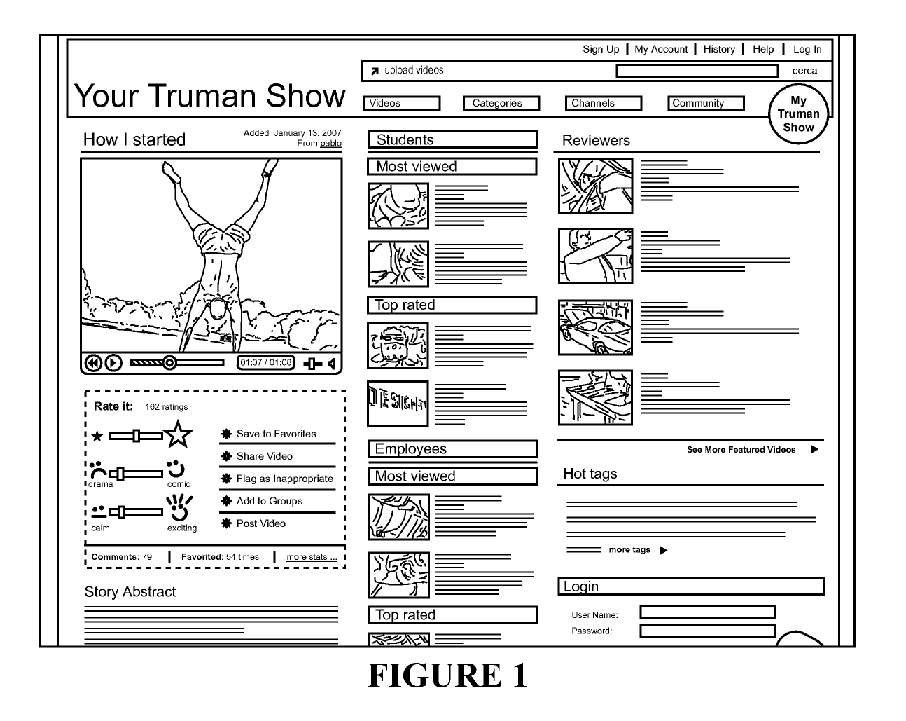

Referring to FIG. 1, an exemplary screenshot of a webpage of the networking system is shown. A left top portion of the webpage comprises a video published by a member. By posting the video, the member becomes a publisher. Additionally, the publisher may post a story abstract associated with the video (e.g., shown at a bottom left portion).

One or more other members may view this video by accessing the video via a webpage. While viewing or after viewing the video, the viewer may rate the video, and thus become a reviewer for the video. As shown in FIG. 1, a ratings section is provided near the video. In exemplary embodiments, the ratings section provides a scale rating system for a plurality of ratings categories. In the example of FIG. 1, the ratings categories comprise an overall category, a drama/comic category, and a calm/exciting category. Alternative embodiments may comprise other ratings categories and may comprise any number of ratings categories (i.e., not limited to three as shown).

While a scale rating system is provided in FIG. 1, alternative embodiments may utilize other forms of rating systems. For example, the ratings may be provided via a number scheme (e.g., rate from 1 to 5), a star scheme (e.g., 1 star to 4 stars) or any other means for indicating a rating.

The ratings section also comprises a “save to favorites” selection. By saving the video to the member's favorites, a “favorited” count is incremented (e.g., “favorited 54 times”). The ratings section further provides other statistics such as number of comments left by reviewers.

In exemplary embodiments, a middle portion of the webpage provides a listing of videos based on rankings. For example, most viewed and top rated videos may be listed. The listing may be based on particular types of members. In the present embodiment, the listings are ranked for students and employees. Alternative embodiments may utilize other types of members for ranking purposes and other categories of ranking (e.g., most reviews, etc.).

The exemplary webpage may further comprise a reviewers' portion (e.g., on a right side of the webpage). In exemplary embodiments, the reviewers' portion provides links to reviews posted by reviewers of the current video and/or other videos. By selecting one of the links, the viewer sees the review posted by the reviewer.

According to exemplary embodiments, the viewer may rate the reviewers' reviews. That is, the viewer may “vote” on the review by agreeing with the review (e.g., “=”), rating the review as negative or not well written (e.g., “−”), or rating the review as positive or very well written (e.g., “+”). Alternative embodiments may utilize other forms of rating systems. For example, the ratings may be provided via a number scheme (e.g., rate from 1 to 5), a star scheme (e.g, 1 star to 4 stars) or any other means for indicating a rating.

Based on the various rating schema, one or more scores or rankings may be associated with each member. One such score type is a publisher score. For each member that publishes video to the network a publisher or video score is assigned to each video of the publisher. A number of viewers and reviews is factored into the publisher/video score. In some embodiments, an overall publisher score (e.g., average of all publisher/video scores for all, their published videos) may be maintained.

A second score type which may be associated with a member is a reviewer score. The reviewer score is based on ratings received for the member's reviews of videos posted by others.

In some embodiments, links to videos or member webpages may be listed based on the publisher/video score and/or the reviewer score. Thus, for example, the middle portion of the webpage, or other portion, may provide a listing of video links based on the top publisher scores or the top reviewer scores.

### Publisher Ranking

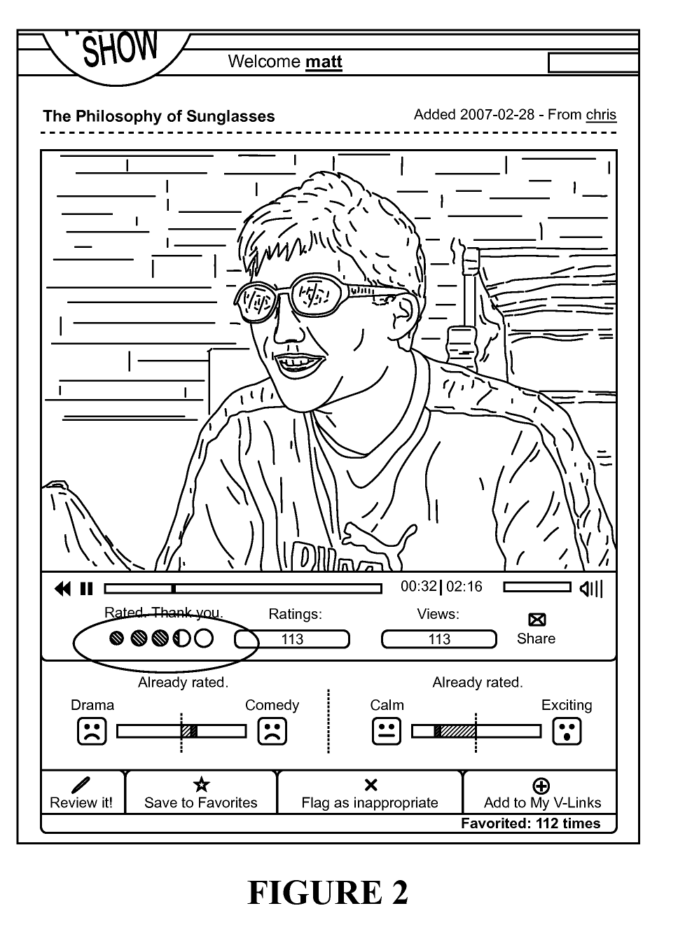

Referring to FIG. 2, a screenshot of a webpage of the video-based networking system having a video rating scale is illustrated. In various embodiments, users are allowed to view and rate the videos stored online and published on the site. A user can also upload and publish a video. Users of the site can rate the video by using a rating scale. As shown in FIG. 2, the video can have a rating (e.g. 1-5), and can be placed on a spectrum from drama to comedy, or on a spectrum from calm to exciting. Various other ratings and categorization of videos are also possible.

In one embodiment, each video has a score that is calculated as the average value of the ratings received. A video gains one “view” each time the page containing the video is opened by a user. Publishers can be ranked by means of an algorithm that uses as inputs each video's score and number of views. In various embodiments, the objective of the publisher ranking algorithm is to:

a. reward users who produce high quality videos

b. reward users who produce the most videos

c. reward users who consistently produce videos over time

d. provide the opportunity for new users to rise rapidly in the ranking

e. make the publisher rankings as dynamic as possible

f. stimulate a competitive environment among users

In one embodiment, a user can choose to rate a video by selecting a value on a scale positioned in the vicinity of the video itself. Each video can have a score that is calculated as the simple average of the ratings received.

### Algorithm to Compute Overall Publisher Score and Ranking

In one embodiment, the algorithm is based on the “moving average” mathematical function. The publisher rank can be calculated and updated every day at a specific time. Each user has n videos: v1 . . . vn. Each video has a video score value of: r1 . . . m (e.g. r1=the sum of all the ratings for video number 1/n ratings). For each video, the system can record how many views it received daily during each of the preceding specified number of (e.g. seven) days. For example, on day eight (8) the views count for each video would be recorded as illustrated in the following table:

views_day1(v1)
views_day2(v1)
views_day3(v1)
views_day4(v1)
views_day5(v1)
views_day6(v1)
views_day7(v1)
views_day1(v2)
. . .
Views_day7(v2)
. . .
views_day1(vn)
. . .
Views_day7(vn)

In one embodiment, the following day, all the values can be shifted backwards by one position: the first day's value is lost to leave space in the seventh position to those of current day (day 8). As an illustration, the status at Day 9 would be:

views_day1(v1)=views_day2(v1)
views_day2(v1)=views_day3(v1)
views_day3(v1)=views_day4(v1)
views_day4(v1)=views_day5(v1)
views_day5(v1)=views_day6(v1)
views_day6(v1)=views_day7(v1)
views_day7(v1)=views of video 1 of the previous day (day 8)
views_day1(v2)=views_day2(v2)
. . .
Views_day7(v2)=views of video 2 of the previous day
. . .
views_day1(vn)=views_day2(vn)
. . .
Views_day7(vn)=views of video 2 of the previous day

In one embodiment, the formula to calculate the daily publisher score is: (average of score r1 . . . rn)×(the sum of the number of views of each video over the previous 7 days). Stated alternatively: [(r1+r2+r3+. . . +rn)/n]*[[views_day1(v1)+views_day2(v1)+ . . . +views_day7(v1)]+[views_day1(v2)+views_day2(v2)+ . . . +views_day7(v2)]+ . . . +[views_day1(vn)+views_day2(vn)+ . . . +views_day7(vn)]]. In alternative embodiments, a greater or lesser number of days can be used. In various embodiments, the results of the algorithm can be stored in a computer readable medium (e.g. database) and can be displayed to the various users of the system.

This algorithm can potentially generate very large numbers. It is therefore preferable to use a ranking in which the publisher with the top score ranks first, the publisher with the second best score ranks second and so forth. With the ranking mechanism each user can be unequivocally aware of his/her ranking in comparison to other publishers, which would not be the case by only using each publisher's score to compare. The following table shows a ranking of n number of publishers:

| User | Ranking | Score |
|---|---|---|
| Gianni | 1 | 2,574,567 |
| Mario | 2 | 2,184,094 |
| Fabrizio | 3 | 2,105,789 |
| . . . | . . . | . . . |
| Last User | N | 1,235 |

### Reviewer Ranking

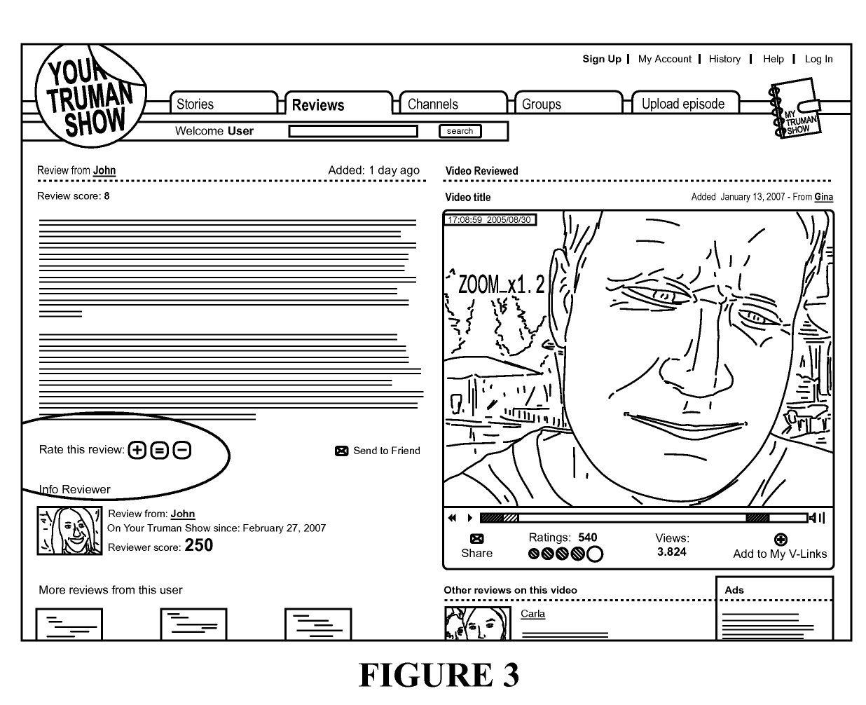

Referring to FIG. 3, a screenshot of a webpage of the video-based networking system having a reviewer rating is shown. In various embodiments, the video-based networking system allows users to review the videos stored online and published on the site. Any user may write a review and publish it. As illustrated in FIG. 3, users of the site can rate the review by selecting the plus, minus, or equal symbol.

In one embodiment, each review has a score that is calculated as the algebraic sum of the ratings received. A review gains one “view” each time the page containing the review is opened by a user. Reviewers are ranked by means of an algorithm that uses as inputs the each review's score and number of views. The objective of the reviewer ranking algorithm is generally to:

a. reward users who write high quality reviews

b. reward users who produce the most reviews

c. reward users who are consistently writing over time

d. provide the opportunity for new users to rise rapidly in the ranking

e. to make the reviewer rankings as dynamic as possible

f. to stimulate a competitive environment among users

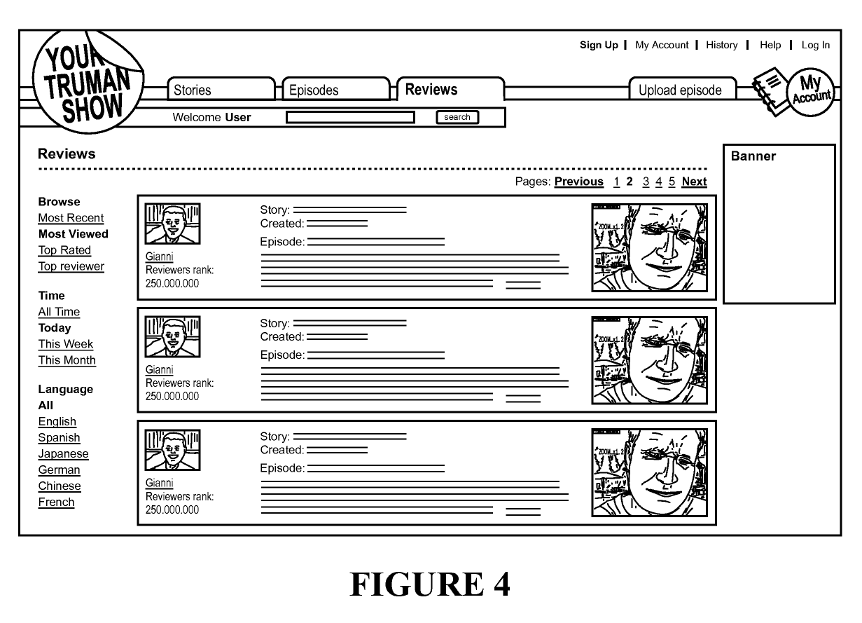

Referring to FIG. 4, a screenshot of a webpage of the video-based networking system having a listing of reviews is illustrated. As shown in FIG. 4, the webpage can display a set of reviews from one or more users of the system.

In one embodiment, any user can choose to rate a review, by selecting one of three possible ratings.: (−) (=) (+). Each review has a score that is calculated as the result of the sum of the votes received. If the user selects (−) the score decreases by 1 (−1). If the user selects (=) the score increases by 0. If the user selects (+) the score increases by 1 (+1). In this embodiment, the final review score can have a negative value.

### Algorithm to Compute Overall Reviewer Score and Ranking

In one embodiment, the algorithm is based on the “moving average” mathematical function. The reviewers rank is calculated and updated every day at a specific time. Each user has n reviews: v1 . . . vn. Each review has a review score value of: r1 . . . m (e.g. r1=the algebraic sum of all the votes for review number 1). For each review, the system records how many views it received daily during each of the preceding seven days. As an illustration, on day eight (8), the views count for each review would be recorded as shown in the following table. Status at Day 8:

views_day1(v1)
views_day2(v1)
views_day3(v1)
views_day4(v1)
views_day5(v1)
views_day6(v1)
views_day7(v1)
views_day1(v2)
. . .
views_day7(v2)
. . .
views_day1(vn)
. . .
Views_day7(vn)

In one embodiment, the following day, all the values are shifted backwards by one position: the first day's value is lost to leave space in the seventh position to those of current day (day 8). As an illustration, the status at Day 9 would be:

views_day1(v1)=views_day2(v1)
views_day2(v1)=views_day3(v1)
views_day3(v1)=views_day4(v1)
views_day4(v1)=views_day5(v1)
views_day5(v1)=views_day6(v1)
views_day6(v1)=views_day7(v1)
views_day7(v1)=views of review 1 of the previous day (day 8)
views_day1(v2)=views_day2(v2)
. . .
Views_day7(v2)=views of review 2 of the previous day
. . .
views_day1(vn)=views_day2(vn)
. . .
Views_day7(vn)=views of review 2 of the previous day

In one embodiment, the formula to calculate the daily reviewer score is: (the algebraic sum of scores r1 . . . rn)×(the sum of the number of views of each review over the previous 7 days). Stated alternatively: [(r1+r2+r3+ . . . +m)]*[[views_day1(v1)+views_day2(v1)+ . . . +views_day7(v1)+views_day1(v2)+views_day2(v2)+ . . . +views_day7(v2)+ . . . +views_day1(vn)+views_day2(vn)+ . . . +views_day7(vn)]]. In alternative embodiments, a greater or lesser number of days can be used. In various embodiments, the results of the algorithm can be stored in a computer readable medium (e.g. database) and can be displayed to the various users of the system.

In one embodiment, the ranking of the reviewer is based on the results of this formula. With the ranking mechanism, each user can be unequivocally aware of his/her ranking in comparison to other reviewers, which would not be the case by only using each reviewer's score to compare.

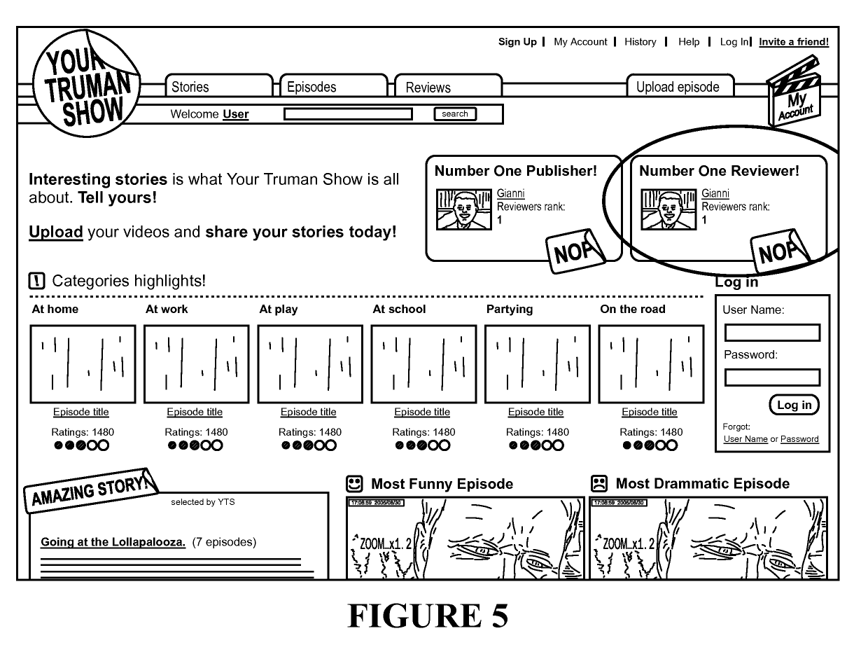

Referring to FIG. 5, a screenshot of a webpage of the video-based networking system having reviewer ranking is shown. The reviewers can be ranked in order from highest to lowest rank. As illustrated in FIG. 5, the user “Gianni” is ranked as the number one reviewer and this information can be displayed on the webpage. For other users, their respective reviewer rank can also be shown on an appropriate webpage. The following table illustrates the ranking of n number of reviewers:

| User | Ranking | Score |
|---|---|---|
| Gianni | 1 | +1,030,023 |
| Mario | 2 | +950,769 |
| Fabrizio | 3 | +753,054 |
| . . . | . . . | . . . |
| Giorgio | n − 1 | −1,245,768 |
| Last User | n | −1,324,987 |

The above-described functions and components can be comprised of instructions that are stored on a computer-readable storage medium. The instructions can be retrieved and executed by a processor. Some examples of instructions are software, program code, and firmware. Some examples of storage medium are memory devices, tape, disks, integrated circuits, and servers, The instructions are operational when executed by the processor to direct the processor to operate in accord with embodiments of the present invention. Those skilled in the art are familiar with instructions, processor(s), and computer-readable storage medium.

The various embodiments include a computer program product which is a storage medium (media) having instructions stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, microdrives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information. The computer program product can be transmitted in whole or in parts and over one or more public and/or private networks wherein the transmission includes instructions which can be used by one or more processors to perform any of the features presented herein. In various embodiments, the transmission may include a plurality of separate transmissions.

The present invention has been described above with reference to exemplary embodiments. It will be apparent to those skilled in the art that various modifications may be made and other embodiments can be used without departing from the broader scope of the invention. For example, the different components of the networking system (e.g., video, ranking lists, etc.) may be positioned in other locations on the website. Therefore, these and other variations upon the exemplary embodiments are intended to be covered by the present invention.

What is claimed is:

1. A method for ranking a member of a video-based networking system, said method comprising:
receiving one or more ratings associated with said member and computing an average value of said ratings;
receiving one or more views associated with said member and computing a number of said views;
determining a ranking for said member based on the average value of said ratings and the number of said views; and
providing the ranking to the member of the video-based networking system.

2. The method of claim 1 wherein the one or more ratings is associated with a video in the video-based networking system.

3. The method of claim 1 wherein the one or more ratings is associated with a review of a video in the video-based networking system.

4. The method of claim 1 further comprising providing a listing of reviewers based on the ranking.

5. The method of claim 1 wherein determining the ranking comprises computing a number of viewers over a time period.

6. The method of claim 5 wherein the time period is a specified number of days.

7. The method of claim 1 wherein determining the ranking comprises computing a review score value.

8. The method of claim 7 wherein the review score value comprises an algebraic sum of all votes on reviews associated with the member over a time period.

9. The method of claim 7 wherein calculating the ranking comprises multiplying the review score value associated with the member with a sum of a number of views over a period of time.

10. The method of claim 1, further comprising:
displaying the ranking of said member to a set of users of the video-based networking system on a graphical user interface.

11. A video-based networking system for providing ranking of a member, said system comprising:
a server that provides a plurality of videos for viewing by the member of the video-based networking system; and
a ranking module that computes an average value of ratings associated with said member and a number of views associated with said member and determines a ranking for said member based on the average value of said ratings and the number of views; and
an interface that displays said ranking to the member of the video-based networking system.

12. The video-based networking system of claim 11, further comprising:
a database that stores the ranking of said member, said database accessible by the server.

13. The video-based networking system of claim 11, wherein the one or more ratings is associated with a video in the video-based networking system.

14. The video-based networking system of claim 11, wherein the one or more ratings is associated with a review of a video in the video-based networking system.

15. The video-based networking system of claim 11, further comprising providing a listing of reviewers based on the ranking.

16. The video-based networking system of claim 11, wherein determining the ranking comprises computing a number of viewers over a time period.

17. The video-based networking system of claim 16, wherein the time period is a specified number of days.

18. The video-based networking system of claim 11, wherein determining the ranking comprises computing a review score value.

19. The video-based networking system of claim 18, wherein the review score value comprises an algebraic sum of all votes on reviews associated with the member over a time period.

20. A computer-readable medium carrying one or more sequences of instructions for ranking a member of a video-based networking system, which instructions, when executed by one or more processors, cause the one or more processors to carry out the steps of:
receiving one or more ratings associated with said member and computing an average value of said ratings;
receiving one or more views associated with said member and computing a number of said views;
determining a ranking for said member based on the average value of said ratings and the number of said views; and
providing the ranking to the member of the video-based networking system.
